(19) United States
(12) Patent Application Publication
(10) Pub. No.: US 2026/0147550 A1
(43) Pub. Date: May 28, 2026

(54) METHOD, APPARATUS, DEVICE AND STORAGE MEDIUM FOR CREATING APPLICATION

(71) Applicants: Beijing Zitiao Network Technology Co., Ltd., Beijing (CN); Lemon Inc., Grand Cayman (KY)

(72) Inventors: Sida SHU, Beijing (CN); Shenghuan NAN, Beijing (CN); Renkai SHAN, Beijing (CN); Cankun LI, Beijing (CN); Qiyu YAO, Singapore (SG); Chao WANG, Beijing (CN); Kun FENG, Beijing (CN); Yu YANG, Beijing (CN); Wenqi WU, Beijing (CN); Yapeng ZHANG, Beijing (CN); Qinghua LIU, Beijing (CN); Mengjing BI, Beijing (CN); Zhulin HE, Beijing (CN); Jinning MAI, Beijing (CN); Junjie WANG, Beijing (CN); Yuliang CHEN, Beijing (CN)

(21) Appl. No.: 19/184,589

(22) Filed: Apr. 21, 2025

(30) Foreign Application Priority Data
Nov. 28, 2024 (CN) 202411733858.9

(51) Int. Cl. G06F 8/38; G06F 8/34

(52) U.S. Cl. CPC G06F 8/38; G06F 8/34

(57) ABSTRACT

Embodiments of the disclosure relate to a method, apparatus, device and storage medium for creating an application. An example method includes: presenting an editing canvas for editing a graphical interface corresponding to a target workflow; acquiring configuration information of a graphical component in the editing canvas via a configuration window corresponding to the graphical component, the configuration information indicating an association between a first attribute of the graphical component and a target workflow or an additional workflow; and based on the configuration information, creating a target application corresponding to the target workflow.

### CROSS REFERENCE

This application claims priority to Chinese Patent Application No. 202411733858.9, filed on Nov. 28, 2024 and entitled “METHOD, APPARATUS, DEVICE AND STORAGE MEDIUM FOR CREATING APPLICATION”, the entirety of which is incorporated herein by reference.

### FIELD

Example embodiments of the disclosure generally relate to the field of computers, and in particular to a method, apparatus, device, and computer-readable storage medium for creating an application.

### BACKGROUND

With the development of computer technologies, generative models are gradually applied to various aspects of people's lives. Some platforms also support users to configure various types of applications, such as agents or bots based on generative models. In a traditional scenario, such an application usually interacts through a fixed interaction interface (for example, a dialog interface), which greatly affects the interaction efficiency of the users.

### SUMMARY

In a first aspect of the disclosure, a method for creating an application is provided. The method includes: presenting an editing canvas for editing a graphical interface; acquiring, via a configuration window corresponding to the graphical component in the editing canvas, configuration information of the graphical component, the configuration information indicating an association between a first attribute of the graphical component and a target workflow; and creating a target application associated with the target workflow based on the configuration information.

In a second aspect of the disclosure, an apparatus for creating an application is provided. The apparatus includes a presentation module configured to present an editing canvas for editing a graphical interface; an acquisition module configured to acquire, via a configuration window corresponding to the graphical component in the editing canvas, configuration information of the graphical component, the configuration information indicating an association between a first attribute of the graphical component and a target workflow; and a creation module configured to create a target application associated with the target workflow based on the configuration information.

In a third aspect of the disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method according to the first aspect.

In a fourth aspect of the disclosure, a computer-readable storage medium is provided. The computer-readable storage medium stores computer programs thereon, and the computer programs are executable by a processor to implement the method according to the first aspect.

It should be understood that the contents described in this content section are not intended to limit the key features or important features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the disclosure may be implemented;

FIGS. 2A-2D illustrate example interfaces according to some embodiments of the disclosure;

FIG. 3 illustrates a flowchart of an example process of creating an application according to some embodiments of the disclosure;

FIG. 4 illustrates a schematic structural block diagram of an example apparatus for creating an application according to some embodiments of the disclosure; and

FIG. 5 illustrates a block diagram of an electronic device capable of implementing various embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limitation to the embodiments set forth herein. Rather, these embodiments are provided for a more thorough and complete understanding of the disclosure. It should be understood that the drawings and embodiments of the disclosure are for exemplary purposes only and are not intended to limit the scope of the disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment(s) described in the same section/subsection and/or in different sections/subsections.

In the description of the embodiments of the disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the disclosure may relate to data of a user, acquisition and/or use of data, and the like. These aspects all follow the corresponding laws and regulations and related regulations. In the embodiments of the disclosure, collection, acquisition, conduction, processing, forwarding, use, and the like of all data are performed on the premise that the user's knowledge and confirmation. Accordingly, when implementing the embodiments of the disclosure, a type, usage scope, usage scenario, and the like of data or information, that may be involved, should be notified to the user and obtain the authorization from the user in an appropriate manner according to the relevant laws and regulations. The specific notification and/or authorization manner may vary according to actual situations and application scenarios, and the scope of the disclosure is not limited in this respect.

According to the solutions in the specification and the embodiments, for example, in which personal information processing is involved, may be performed on the premise of having a legality basis (for example, obtaining consent of a personal information subject, or necessary for fulfilling contract), and may be performed only within a specified or agreed range. The user's refusal to process personal information other than the information necessary for the basic function will not affect the user's usage on the basic function.

Some platforms also support users to configure various types of applications, such as agents or bots based on generative models. In a traditional scenario, such an application usually interacts through a fixed interaction interface (for example, a dialog interface), which greatly affects user interaction efficiency.

The embodiment of the disclosure provides a solution for creating an application. The solution includes: presenting an editing canvas for editing a graphical interface; acquiring, via a configuration window corresponding to the graphical component in the editing canvas, configuration information of a graphical component, the configuration information indicating an association between a first attribute of the graphical component and a target workflow; and creating a target application associated with the target workflow based on the configuration information.

In this way, the embodiments of the disclosure provide a canvas editing tool corresponding to a workflow to support a user to create a graphical interface corresponding to the workflow. Such a graphical interface can cooperate with the workflow, improving the interaction efficiency of the application.

Various example implementations of this solution are described in detail below in conjunction with the accompanying drawings.

### Example Environment

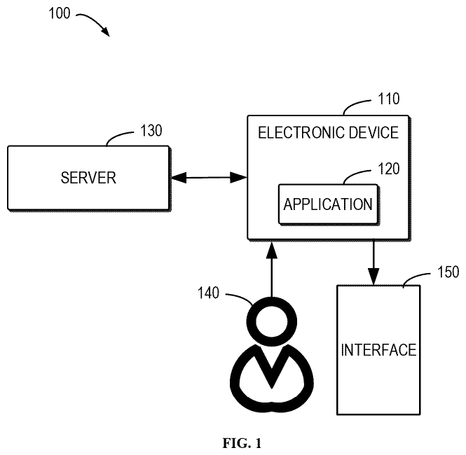

FIG. 1 illustrates a schematic diagram of an example environment 100 in which embodiments of the disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, an example of which may include, but are not limited to, a development application or other suitable applications. The user 140 may interact with the application 120 via the electronic device 110 and/or its attachment device.

In the environment 100 of FIG. 1, if the application 120 is in an active state, the electronic device 110 may present, through the application 120, an interface 150 for supporting creation of an application.

In some embodiments, the electronic device 110 communicates with the server 130 to implement provision of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired mode or a wireless mode. The communication connection may include, but is not limited to, a Bluetooth connection, a mobile network connection, a Universal Serial Bus (USB) connection, a Wireless Fidelity (WiFi) connection, and the like, and the embodiments of the disclosure are not limited in this aspect. In an embodiment of the disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the disclosure.

Some example embodiments of the disclosure will be described below with continued reference to the accompanying drawings.

### Example Interaction

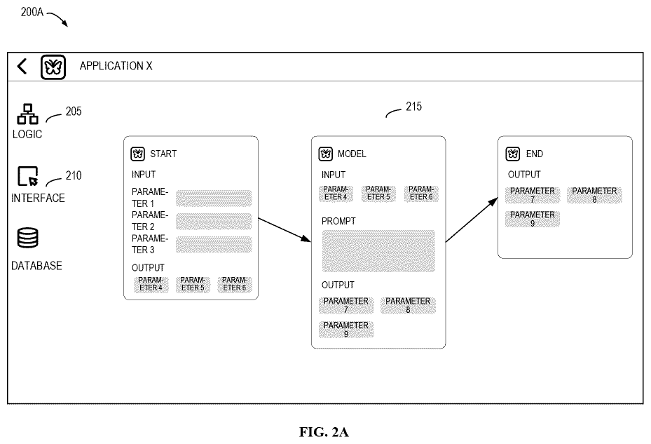

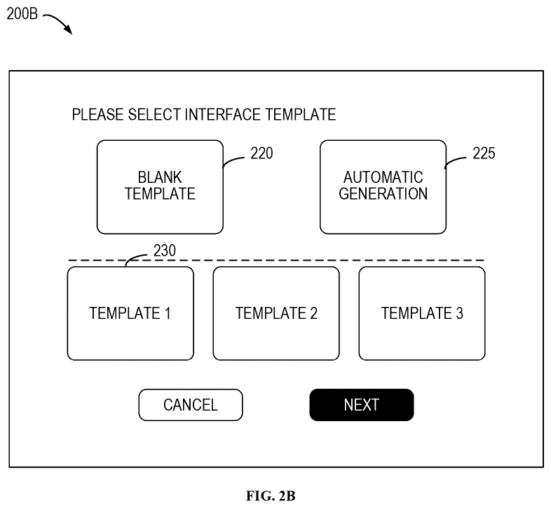

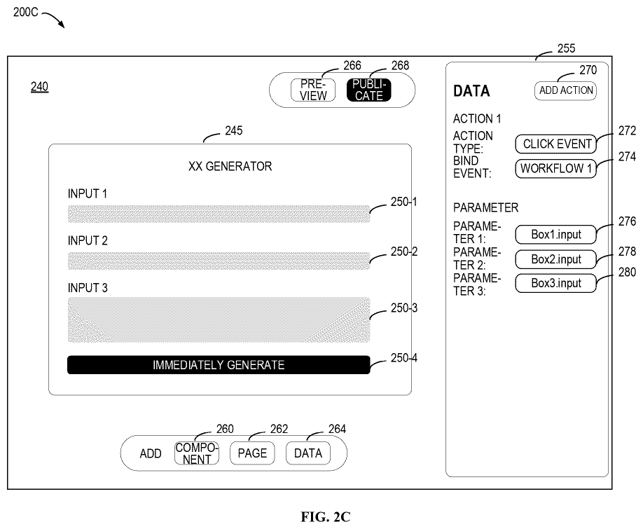

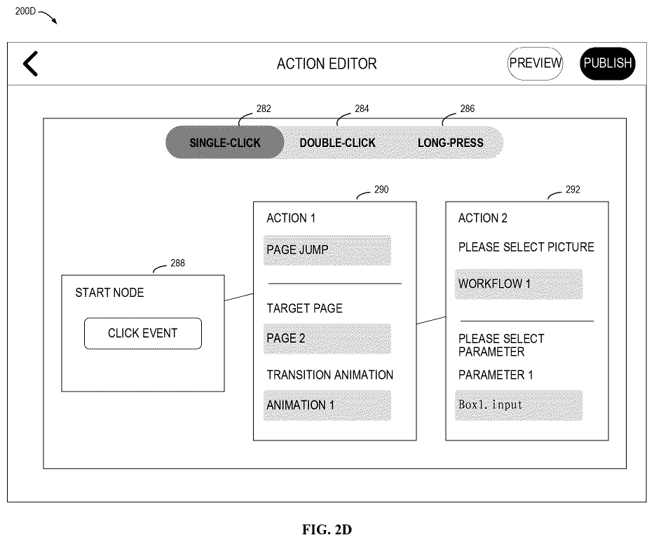

An example interaction of creating an application according to some embodiments of the disclosure will be described below in conjunction with FIGS. 2A-2D. FIGS. 2A-2D illustrate example interfaces 200A-200D, in accordance with some embodiments of the disclosure. The interfaces 200A-200D may be provided, for example, by the electronic device 110 shown in FIG. 1.

FIG. 2A illustrates an editing interface 200A of an application. Such an editing interface 200A may be used, for example, to create an appropriate application based on the workflow. As an example, such an application may be an agent, bot, or other appropriate workflow-based application built based on a generative model.

As shown in FIG. 2A, in the editing interface 200A, the electronic device 110 may present a created workflow 215. The workflow 215 may include a plurality of processing nodes to support triggering execution of the plurality of processing nodes according to the logic indicated by the workflow 215. In some examples, the workflow 215 may include a model node corresponding to the generative model. The model node may trigger processing of corresponding input parameters using the configured generative model to generate corresponding output parameters.

In some embodiments, the editing interface 200A may include, for example, a plurality of label pages. The electronic device 110 may present an editing page corresponding to the workflow based on the selection of a label item 205.

Additionally, the electronic device 110 may further provide a canvas entry 210 to support the user to create a graphical interface corresponding to the target application in the editing canvas.

In some embodiments, in response to the selection of the canvas entry 210, the electronic device 110 may present a window 200B as shown in FIG. 2B. In the window 200B, electronic device 110 may provide a set of candidate interface templates 230. In some embodiments, such a set of candidate interface templates 230 may include a preset interface template. Each interface template may be associated with one or more graphical interfaces.

In some embodiments, such a set of candidate interface templates 230 may be, for example, determined from a library of templates. For example, one or more interface templates that are matched with the workflow 215 may be determined by the electronic device 110 from a target library based on the workflow 215 and displayed in the window 200B. Further, the electronic device 110 may, for example, receive a selection of the interface template 230, and may present, in the editing canvas, one or more graphical interfaces and/or graphical components corresponding to the interface template(s) 230.

In some embodiments, the electronic device 110 may also receive a selection of a blank template 220 and present a blank canvas to support the user to add a graphical component in the blank canvas, for example.

In some embodiments, the electronic device 110 may also provide a generation entry 225. The electronic device 110 may receive a selection of the generation entry 225 and may provide one or more graphical interfaces and/or graphical components created based on the content of the workflow 215 on the editing canvas.

In some embodiments, the electronic device 110 and/or the server 130 may, for example, determine a set of input parameters and/or a set of output parameters of the workflow 215. Further, the electronic device 110 and/or the server 130 may create a corresponding set of input graphical components and a set of graphical output components based on the set of input parameters and/or the set of output parameters.

In other embodiments, the electronic device 110 and/or the server 130 may also utilize the generative model to generate at least one graphical component corresponding to the workflow 215. For example, the electronic device 110 and/or the server 130 may determine description information of the workflow 215. In some embodiments, such description information may include a structural representation of the workflow 215.

Further, the electronic device 110 and/or the server 130 may provide the structural representation to the generative model to generate a corresponding code representation. Further, the electronic device 110 may present a graphical interface and/or an image component corresponding to the workflow 215 based on the generated code representation.

As shown in FIG. 2C, the electronic device 110 illustrates an example editing interface 200C. In the editing interface 200C, the electronic device 110 may provide an editing canvas 240 to support a user to design a graphical interface of an application in a graphical mode.

As shown, the editing canvas 240 may include, for example, a graphical interface 245. The graphical interface 245 may further include a plurality of graphical components, such as a graphical component 250-1, a graphical component 250-2, a graphical component 250-3, and a graphical component 250-4 (individually or collectively referred to as a graphical component 250). As an example, the graphical components 250-1 to 250-3 may correspond to input components. The graphical component 250-4 may correspond to a button component.

In some embodiments, the electronic device 110 may also present a set of component templates associated with the editing canvas 240. As an example, the electronic device 110 may receive a user selection of a control 260 and present a plurality of preset component templates. The plurality of component templates may correspond to different types of graphical components, such as a text input component, an image input component, a table display component, an image display component, and the like.

Further, the electronic device 110 may receive a selection of a component template in a set of component templates, and may add a graphical component corresponding to a target component template in the editing canvas. For example, the electronic device 110 may add a corresponding graphical component in the editing canvas 240 by dragging the component template.

In some embodiments, the electronic device 110 may also support creating a plurality of graphical interfaces in the editing canvas 240. As an example, the electronic device 110 may receive a selection of a control 262 to create a new graphical interface.

In some other embodiments, the electronic device 110 may also support associating the editing canvas 240 to other workflows. As an example, the workflow 215 may be associated with the editing canvas 240 by default. The electronic device 110 may also receive a selection of a control 264 (also referred to as an addition entry) and may present a set of candidate workflows. Such a set of candidate workflows may include, for example, a workflow that the current user has permission to access.

In some embodiments, the electronic device 110 may receive a selection of one or more workflows of the set of candidate workflows and may associate the one or more workflows to the editing canvas 240 to support establishing an association between the graphical component and the workflow.

In some embodiments, the electronic device 110 may also support a user to view a data source associated with the editing canvas 240. As an example, the electronic device 110 may provide a data viewing control (not shown) in the editing interface 200B, for example, and may present a set of workflows associated with the editing canvas 240 based on the data viewing control. Further, the electronic device 110 may, for example, support a user to perform an association between the editing canvas 240 and the workflow. The electronic device 110 may support disassociating other workflows other than the workflow 215 from the editing canvas 240.

Further, as shown in FIG. 2C, the electronic device 110 may also receive a selection of the graphical component 250, and may present a configuration window 255 for the graphical component 250.

The electronic device 110 may, for example, present one or more editing controls in the configuration window 255. In some embodiments, the electronic device 110 may present a set of candidate items based on a selection of the editing control. In some scenarios, such a set of candidate items may be determined based on a data source associated with the editing canvas 240. For example, the set of candidate items may correspond to the workflow 215 or other added workflows. Further, the electronic device 110 may receive a selection of a particular candidate item to configure a corresponding attribute of the graphical component 250-4 as the selected candidate item.

Taking FIG. 2C as an example, the electronic device 110 may, for example, receive a user selection of the graphical component 250-4 (e.g., a button component) and present a configuration window 255 of the button component. For example, in the configuration window 255, the electronic device 110 may support the user to add an action corresponding to the button component by clicking a control 270.

As an example, the electronic device 110 may provide a control 272 for configuring a work type. For example, the electronic device 110 may configure, via the control 272, a type of the action as a click event, a double-click event, a long-press event, or the like.

Additionally, the electronic device 110 may further provide a control 274 to configure an action triggered by the click event. For example, the electronic device 110 may receive a selection of the control 274 to present one or more action flows associated with the editing canvas 240.

Further, the electronic device 110 may receive a selection of a “workflow 1” to support that the click event may be triggered to execute the “workflow 1”. In some embodiments, the electronic device 110 may further support, for example, a user to configure, through the control 274, the triggered action as executing a partial node in a specified action flow.

In some embodiments, as shown in FIG. 2C, in a case that the triggered action includes executing the workflow or the partial node in the workflow, the electronic device 110 may also accordingly present a parameter configuration control associated with executing the workflow or the node. For example, the parameter configuration controls 276, 278, and 280 may be used to configure 3 parameters that are required to be introduced for executing the “workflow 1”.

In some embodiments, the electronic device 110 may configure an input parameter 1 of the “workflow 1” to match with input information of the graphical component 250-1 through the parameter configuration control 276 (e.g., a field, Box1.input). Similarly, an input parameter 2 of the “workflow 1” is configured to match with input information of the graphical component 250-2 (e.g., a field, Box2.input); and an input parameter 3 of the “workflow 1” is configured to match with input information of the graphical component 250-3 (e.g., field, Box3.input).

In this way, the electronic device 110 may determine configuration information of the graphical interface 245, and may establish an association between attributes of one or more graphical components 250 in graphical interface 245 and the workflow.

As an example, in the usage phase of an application, the user may provide three input parameters through the graphical interface 245 and may trigger the invoking of the “workflow 1” by clicking a button, and three input parameters input by the user may be provided to the “workflow 1” as corresponding variables.

In some embodiments, the electronic device 110 may further support creating a content display component in the editing canvas 240, and configure the contents to be displayed by the content display component. Similarly, the electronic device 110 may present at least one output parameter in the one or more workflows associated with the editing canvas 240 through a configuration control.

Taking the workflow 215 shown in FIG. 2A as an example, the electronic device 110 may provide three candidate items, i.e., “parameter 7”, “parameter 8”, and “parameter 9”. Further, the electronic device 110 may receive a selection of one or more of the three candidate items.

For example, if the contents to be displayed by the content display component is associated with the “parameter 7” of the workflow 215, the created application may acquire the content of the output “parameter 7” during runtime, and display it in the content display component accordingly. In some embodiments, the content display component may, for example, support streaming out the output results of the workflow, e.g., an output text.

In some embodiments, the electronic device 110 may further support the user to associate a plurality of output parameters to the same content display component. For example, the content to be displayed by the content display component may be simultaneously associated to the “parameter 7” (e.g., the text output) and the “parameter 8” (e.g., an image output) of the workflow 215. Accordingly, in an application running process, the application may acquire the contents of the “parameters 7” and the “parameter 8”, and may display corresponding results in series or in parallel.

In some embodiments, the editing canvas 240 may also support the addition of other types of graphical components, for example. For example, the editing canvas 240 may support adding a dialog component to support a user to input information in a dialog interaction mode. In some embodiments, the electronic device 110 may also support configuration of one or more attributes of the dialog component, such as a profile picture displayed in the dialog component, greeting information in the dialog component (i.e., opening remarks), or suggested input items (e.g., suggested questions), etc.

For example, the user may configure an input item presented in the dialog component to be associated with an output parameter of the workflow 215 by the editing canvas 240. As another example, the user may configure an input message received in the dialog component to invoke a parameter of the workflow 215 by the editing canvas 240.

Additionally, the electronic device 110 may also support the user to configure one or more interaction capabilities associated with the dialog component. For example, the electronic device 110 may support the user to open an audio interaction capability, a picture input capability, a video interaction capability, a file uploading capability, and the like of the dialog component.

In some embodiments, in addition to supporting the configuration of the association between the graphical component in the editing canvas 240 and the workflow, the electronic device 110 may also support configuration of a jumping attribute of the graphical component to support triggering a jump to other graphical interface in the editing canvas 240. In some examples, the electronic device 110 may also configure a specific action (e.g., a double-click action) of the graphical component 250-4 by the configuration window 255 to trigger the jump to the other graphical interface.

In some embodiments, the electronic device 110 may also provide a view editing panel associated with the editing canvas 240, for example. Such a view editing panel may present a plurality of views corresponding to a plurality of graphical interfaces in the editing canvas 240.

Further, each of the views may present a view element corresponding to a graphical component in the graphical interface. Accordingly, the electronic device 110 may receive a selection of the view element, and may configure a jump event corresponding to the view element in a graphical mode. For example, the user may connect a certain view element and another view through the view editing panel to configure a jumping relationship between the view element and the graphical interface.

In some embodiments, the electronic device 110 may also support the user to uniformly configure events and/or actions in the graphical interface through an action editor. FIG. 2D illustrates an example event editing panel 200D, in accordance with some embodiments of the disclosure.

As shown in FIG. 2D, in the event editing panel 200D, the electronic device 110 may present a set of action nodes, e.g., a node 288, a node 290, and a node 292, corresponding to the editing canvas 240. Further, the electronic device 110 may configure a triggering action corresponding to the graphical component via the configuration window corresponding to the set of action nodes.

Taking FIG. 2D as an example, the node 288 may correspond to graphical component 250-4. The electronic device 110 may configure an event type as a “click event” through the node 288.

Further, the node 290 may correspond to a first action performed as being triggered by the “click event”. As shown in FIG. 2D, an action type corresponding to the node 290 may be configured as a “page jump”, jumping to “page 2” with a corresponding transition animation “animation 1”.

Further, the node 292 may correspond to a second action performed after completion of the “page jump” action. As shown in FIG. 2D, an action type corresponding to the node 292 may be configured to execute “workflow 1”. In addition, the electronic device 110 may also configure, through the node 292, one or more parameters associated with executing the “workflow” 1.

In some embodiments, to improve the editing efficiency, the editing canvas 240 may also be associated with a plurality of event editing panels, and the plurality of event panels may correspond to different types of triggering operations.

In some embodiments, the editing canvas is associated with a plurality of event editing panels for configuring triggering actions corresponding to different operation types. For example, the electronic device 110 may provide an event editing panel corresponding to a “single-click operation” 282, an event editing panel corresponding to a “double-click operation” 284, and an event editing panel corresponding to a “long-press operation” 286.

Thus, the embodiments of the disclosure can improve the efficiency of configuring the event logic of the graphical interface.

With continued reference to FIG. 2C, the electronic device 110 may also provide a preview control 266. Further, the electronic device 110 may receive a selection of the preview control 266 (i.e., a preview request) and may present a preview window of the application. In the preview window, the electronic device 110 may present a preview result of the target application.

In some embodiments, the process 300 further includes: presenting a preview window in response to receiving the preview request, the preview window presenting a preview result of the target application. For example, the electronic device 110 may provide a preview window corresponding to a platform to be published by the target application, for example, a personal computer platform or a mobile terminal platform. The electronic device 110 may also support the user to input information in the preview window and trigger the execution of the workflow. Further, the electronic device 110 may further display a corresponding output result in the preview window.

In some embodiments, the electronic device 110 may also support the user selection of a publication control 268 to create an application associated with the workflow. The created application may have a corresponding graphical interface to support the user to more efficiently obtain the workflow service through a mode of graphical interface interaction.

In some embodiments, the electronic device 110 may also generate an access link corresponding to the created application. Accordingly, other users may use the access link to access the created application, to interact based on the graphical interface of the application.

In some embodiments, the electronic device 110 may also support the user to publish the created graphical interface separately. As an example, the electronic device 110 may receive a publication request by which the created graphical interface is published as an interface template, and may correspondingly publish an interface template corresponding to one or more graphical interfaces and/or graphical components in the editing canvas 240. Thus, the embodiments of the disclosure may support other users to more efficiently design the graphical interface using the interface template.

In this way, the embodiments of the disclosure provide a canvas editing tool corresponding to a workflow to support a user to create a graphical interface corresponding to the workflow. Such a graphical interface can cooperate with the workflow, improving the interaction efficiency of the application.

### Example Process

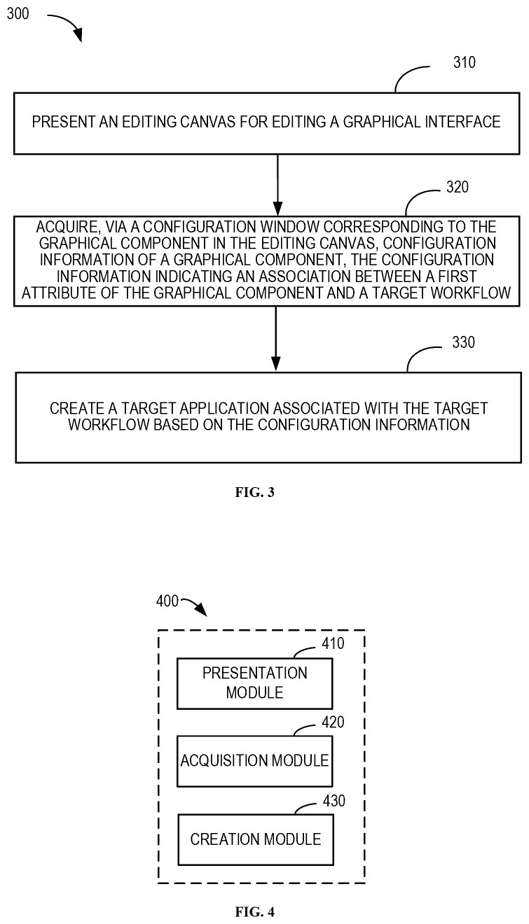

FIG. 3 shows a flowchart of the process 300 for creating an application according to some embodiments of the disclosure. The process 300 may be implemented at the electronic device 110. The process 300 is described below with reference to FIG. 1.

As shown in FIG. 3, at block 310, the electronic device 110 presents an editing canvas for editing a graphical interface.

At block 320, the electronic device 110 acquires, via a configuration window corresponding to the graphical component in the editing canvas, configuration information of a graphical component, the configuration information indicating an association between a first attribute of the graphical component and a target workflow.

At block 330, the electronic device 110 creates a target application associated with the target workflow based on the configuration information.

In some embodiments, presenting the editing canvas for editing the graphical interface further includes: presenting a canvas entry corresponding to the editing canvas; presenting a set of interface templates in response to a selection of the canvas entry; and presenting the editing canvas in response to a selection of a target interface template in the set of interface templates, the editing canvas presenting a set of graphical components corresponding to the target interface template.

In some embodiments, the process 300 further includes presenting, in the editing canvas, at least one graphical component created based on a content of the target workflow.

In some embodiments, the process 300 further includes: creating the at least one graphical component based on a set of input parameters and/or a set of output parameters associated with the target workflow; or processing description information of the target workflow with a generation model to generate the at least one graphical component.

In some embodiments, the process 300 further includes: presenting a set of component templates associated with the editing canvas; and adding, in response to a selection of a target component template in the set of component templates, the graphical component corresponding to the target component template in the editing canvas.

In some embodiments, the process 300 further includes: presenting a data viewing control associated with the editing canvas; and presenting, in response to a selection of the data viewing control, a set of workflows associated with the editing canvas, the set of workflows including the target workflow.

In some embodiments, the process 300 further includes: presenting an addition entry associated with the editing canvas;
presenting a set of candidate workflows in response to a selection of the addition entry; and associating, in response to a selection of at least one workflow of the set of candidate workflows, the at least one workflow with the editing canvas.

In some embodiments, acquiring, via the configuration window corresponding to the graphical component in the editing canvas, the configuration information of the graphical component includes: presenting, in the configuration window, an editing control corresponding to the first attribute; and presenting a set of candidate items in response to a selection of the editing control, the set of candidate items corresponding to the target workflow; and configuring, based on a selection of at least one candidate item of the set of candidate items, a value of the first attribute as the at least one candidate item.

In some embodiments, the first attribute includes an action to be triggered, and the at least one candidate item indicates triggering to execute a workflow or triggering to execute a partial node of the workflow.

In some embodiments, the process 300 further includes: determining, via a configuration window, at least one parameter associated with executing the workflow or the partial node.

In some embodiments, the first attribute includes a content to be displayed, and the at least one candidate item includes at least one output parameter associated with a corresponding workflow.

In some embodiments, the editing canvas is associated with a plurality of graphical interfaces, and the method further includes: configuring a second attribute of the graphical component in a first graphical interface, the second attribute indicating a jump to a second graphical interface of the plurality of graphical interfaces.

In some embodiments, configuring the second attribute of the graphical component in the first graphical interface includes: presenting a view editing panel associated with the editing canvas, the view editing panel displaying a plurality of views corresponding to the plurality of graphical interfaces; and configuring, based on a selection of a view element in the view editing panel, a jumping event corresponding to the view element to indicate that the view element triggers the jump to the second graphical interface.

In some embodiments, acquiring the configuration information of the graphical component includes: presenting an event editing panel corresponding to the editing canvas; in the event editing panel, presenting a set of action nodes corresponding to the editing canvas; and configuring, via a configuration window corresponding to the set of action nodes, a triggering action corresponding to the graphical component.

In some embodiments, the editing canvas is associated with a plurality of event editing panels for configuring triggering actions corresponding to different operation types.

In some embodiments, the process 300 further includes: presenting a preview window in response to receiving a preview request, the preview window presenting a preview result of the target application.

In some embodiments, the process 300 further includes: publishing, in response to a received template publishing request, an interface template corresponding to a set of graphical components in the editing canvas.

### Example Apparatus and Device

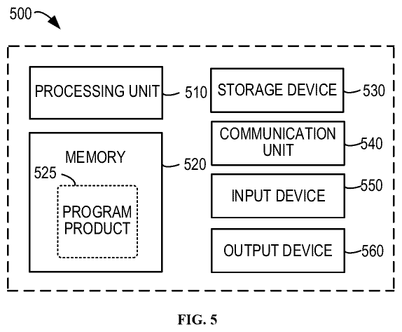

Embodiments of the disclosure also provide a corresponding apparatus for implementing the above method or process. FIG. 4 shows a schematic structural block diagram of an example apparatus 400 for creating an application according to some embodiments of the disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes: a presentation module 410 configured to present an editing canvas for editing a graphical interface; an acquisition module 420 configured to acquire, via a configuration window corresponding to the graphical component in the editing canvas, configuration information of a graphical component, the configuration information indicating an association between a first attribute of the graphical component and a target workflow; and a creation module 430 configured to create a target application associated with the target workflow based on the configuration information.

In some embodiments, the apparatus 400 further includes an entry presentation module configured to: present a canvas entry corresponding to the editing canvas; present a set of interface templates in response to a selection of the canvas entry; and present the editing canvas in response to a selection of a target interface template in the set of interface templates, the editing canvas presenting a set of graphical components corresponding to the target interface template.

In some embodiments, the apparatus 400 further includes a component presentation module configured to present, in the editing canvas, at least one graphical component created based on a content of the target workflow.

In some embodiments, the apparatus 400 further includes a component creation module configured to: create at least one graphical component based on a set of input parameters and/or a set of output parameters associated with the target workflow; or process description information of the target workflow with a generation model to generate the at least one graphical component.

In some embodiments, the apparatus 400 further includes a template presentation module configured to: present a set of component templates associated with the editing canvas; and add, in response to a selection of a target component template in the set of component templates, the graphical component corresponding to the target component template in the editing canvas.

In some embodiments, the apparatus 400 further includes a control presentation module configured to: present a data viewing control associated with the editing canvas; and present a set of workflows associated with the editing canvas in response to a selection of the data viewing control, the set of workflows including the target workflow.

In some embodiments, the apparatus 400 further includes an addition entry presentation module configured to: present an addition entry associated with the editing canvas; present a set of candidate workflows in response to a selection of the addition entry; and associate, in response to a selection of at least one of the set of candidate workflows, at least one workflow to the editing canvas.

In some embodiments, the apparatus 400 further includes an editing control presentation module configured to: present, in the configuration window, an editing control corresponding to the first attribute; and present a set of candidate items in response to a selection of the editing control, the set of candidate items corresponding to the target workflow; and configure, based on a selection of at least one candidate item of the set of candidate items, a value of the first attribute as the at least one candidate item.

In some embodiments, the first attribute includes an action to be triggered, and the at least one candidate item indicates triggering to execute the workflow or triggering to execute a partial node of the workflow.

In some embodiments, the apparatus 400 further includes a determination module configured to determine, via a configuration window, at least one parameter associated with executing the workflow or the partial node.

In some embodiments, the first attribute includes a content to be displayed, and the at least one candidate item includes at least one output parameter associated with a corresponding workflow.

In some embodiments, the apparatus 400 further includes an attribute configuration module configured to: configure a second attribute of the graphical component in a first graphical interface, the second attribute indicating a jump to a second graphical interface of the plurality of graphical interfaces.

In some embodiments, the apparatus 400 further includes a panel presentation module configured to: present a view editing panel associated with the editing canvas, the view editing panel displaying a plurality of views corresponding to the plurality of graphical interfaces; and configure, based on a selection of a view element in the view editing panel, a jumping event corresponding to the view element to indicate that the view element triggers the jump to the second graphical interface.

In some embodiments, the acquisition module 420 is further configured to: present an event editing panel corresponding to the editing canvas; in the event editing panel, present a set of action nodes corresponding to the editing canvas; and configure, via a configuration window corresponding to the set of action nodes, a triggering action corresponding to the graphical component.

In some embodiments, the editing canvas is associated with a plurality of event editing panels for configuring triggering actions corresponding to different operation types.

In some embodiments, the apparatus 400 further includes a preview window presentation module configured to present, in response to receiving a preview request, a preview window presenting a preview result of the target application.

In some embodiments, the apparatus 400 further includes a publishing module configured to publish, in response to a received template publishing request, an interface template corresponding to a set of graphical components in the editing canvas.

FIG. 5 illustrates a block diagram of an electronic device 500 in which one or more embodiments of the disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, the plurality of processing units execute computer-executable instructions in parallel to improve parallel processing capabilities of the electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with another electronic device through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices, such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, there is further provided a computer program product, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of the method, the apparatus, the device, and the computer program product implemented in accordance with the disclosure. It should be understood that each block of the flowchart and/or block diagram, and a combination of various blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by the processing unit of the computer or other programmable data processing apparatus, produce means which implements the functions/acts specified in one or more blocks of the block diagram and/or flowchart. These computer-readable program instructions may also be stored in a computer-readable storage medium and cause the computer, programmable data processing apparatus, and/or other devices to work in a particular mode, such that the computer-readable medium storing instructions includes a manufacture including instructions which implements aspects of the functions/acts specified in one or more blocks of the block diagram and/or flowchart.

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks of the block diagram and/or the flowchart.

The flowchart and block diagrams in the accompanying drawings show an architecture, functionality, and operation that are possibly implemented by systems, methods, and computer program products according to various implementations of the disclosure. In this regard, each block in the flowchart or block diagram may represent a module, a program segment, or a portion of instruction that includes one or more executable instructions for implementing the specified logical function. In some alternative implementations, the functions noted in the blocks may also occur in a different order than noted in the figures. For example, two consecutive blocks may actually be performed substantially in parallel, or may sometimes be performed in the reverse order, depending on the functionality involved. It is also noted that each block in the block diagram and/or flowchart, as well as a combination of blocks in the block diagram and/or flowchart, may be implemented with a dedicated hardware-based system that performs the specified functions or actions, or may be implemented with a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable other ordinary skilled in the art to understand the various implementations disclosed herein.

What is claimed is:

1. A method for creating an application, comprising:
presenting an editing canvas for editing a graphical interface;
acquiring, via a configuration window corresponding to a graphical component in the editing canvas, configuration information of the graphical component, the configuration information indicating an association between a first attribute of the graphical component and a target workflow; and
creating a target application associated with the target workflow based on the configuration information.

2. The method of claim 1, wherein presenting the editing canvas for editing the graphical interface further comprises:
presenting a canvas entry corresponding to the editing canvas;
presenting a set of interface templates in response to a selection of the canvas entry; and
presenting the editing canvas in response to a selection of a target interface template in the set of interface templates, the editing canvas presenting a set of graphical components corresponding to the target interface template.

3. The method of claim 1, further comprising:
presenting, in the editing canvas, at least one graphical component created based on content of the target workflow.

4. The method of claim 3, further comprising:
creating the at least one graphical component based on at least one of a set of input parameters or a set of output parameters associated with the target workflow; or
processing description information of the target workflow with a generative model to generate the at least one graphical component.

5. The method of claim 1, further comprising:
presenting a set of component templates associated with the editing canvas; and
adding a graphical component corresponding to the target component template in the editing canvas in response to a selection of a target component template in the set of component templates.

6. The method of claim 1, further comprising:
presenting a data viewing control associated with the editing canvas; and
presenting, in response to a selection of the data viewing control, the set of workflows comprising the target workflow, a set of workflows associated with the editing canvas.

7. The method of claim 1, further comprising:
presenting an addition entry associated with the editing canvas;
presenting a set of candidate workflows in response to a selection of the addition entry; and
associating at least one workflow of the set of candidate workflows with the editing canvas in response to a selection of the at least one workflow.

8. The method of claim 1, wherein acquiring the configuration information of the graphical component in the editing canvas via the configuration window corresponding to the graphical component comprises:
presenting, in the configuration window, an editing control corresponding to the first attribute; and
presenting a set of candidate items in response to a selection of the editing control, the set of candidate items corresponding to the target workflow; and
configuring, based on a selection of at least one candidate item of the set of candidate items, a value of the first attribute as the at least one candidate item.

9. The method of claim 8, wherein the first attribute comprises an action to be triggered, and the at least one candidate item indicates triggering to execute a workflow or triggering to execute part of nodes of the workflow.

10. The method of claim 9, further comprising:
determining, via the configuration window, at least one parameter associated with execution of the workflow or the part of nodes of the workflow.

11. The method of claim 8, wherein the first attribute comprises content to be displayed, and the at least one candidate item comprises at least one output parameter associated with a corresponding workflow.

12. The method of claim 1, wherein the editing canvas is associated with a plurality of graphical interfaces, and the method further comprises:
configuring a second attribute of a graphical component in a first graphical interface, the second attribute indicating a jump to a second graphical interface of the plurality of graphical interfaces.

13. The method of claim 12, wherein configuring the second attribute of the graphical component in the first graphical interface comprises:
presenting a view editing panel associated with the editing canvas, the view editing panel displaying a plurality of views corresponding to the plurality of graphical interfaces; and
configuring, based on a selection of a view element in the view editing panel, a jumping event corresponding to the view element to indicate that the view element triggers the jump to the second graphical interface.

14. The method of claim 1, wherein acquiring the configuration information of the graphical component comprises:
presenting an event editing panel corresponding to the editing canvas;
presenting, in the event editing panel, a set of action nodes corresponding to the editing canvas; and
configuring, via a configuration window corresponding to the set of action nodes, a triggering action corresponding to the graphical component.

15. The method of claim 14, wherein the editing canvas is associated with a plurality of event editing panels for configuring triggering actions corresponding to different operation types.

16. The method of claim 1, further comprising:
presenting a preview window in response to receiving a preview request, the preview window presenting a preview result of the target application.

17. The method of claim 1, further comprising:
publishing an interface template corresponding to a set of graphical components in the editing canvas in response to a received template publishing request,.

18. An electronic device, comprising:
at least one processor; and
at least one memory coupled to the at least one processor and storing instructions for execution by the at least one processor, the instructions, when executed by the at least one processor, causing the electronic device to perform operations comprising:
presenting an editing canvas for editing a graphical interface;
acquiring, via a configuration window corresponding to a graphical component in the editing canvas, configuration information of the graphical component, the configuration information indicating an association between a first attribute of the graphical component and a target workflow; and
creating a target application associated with the target workflow based on the configuration information.

19. The electronic device of claim 18, wherein presenting the editing canvas for editing the graphical interface further comprises:
presenting a canvas entry corresponding to the editing canvas;
presenting a set of interface templates in response to a selection of the canvas entry; and
presenting the editing canvas in response to a selection of a target interface template in the set of interface templates, the editing canvas presenting a set of graphical components corresponding to the target interface template.

20. A non-transitory computer-readable storage medium having a computer program stored thereon, the computer program being executable by at least one processor to implement operations comprising:
presenting an editing canvas for editing a graphical interface;
acquiring, via a configuration window corresponding to a graphical component in the editing canvas, configuration information of the graphical component, the configuration information indicating an association between a first attribute of the graphical component and a target workflow; and
creating a target application associated with the target workflow based on the configuration information.
